(19) United States
(12) Patent Application Publication
(10) Pub. No.: US 2024/0092195 A1
(43) Pub. Date: Mar. 21, 2024

(54) HIGH-VOLTAGE DEVICE

(71) Applicant: Dr. Ing. h.c. F. Porsche Aktiengesellschaft, Stuttgart (DE)

(72) Inventors: Moritz Eitler, Stuttgart (DE); Oliver Lehmann, Leonberg (DE)

(21) Appl. No.: 18/209,547

(22) Filed: Jun. 14, 2023

(30) Foreign Application Priority Data
Sep. 15, 2022 (DE) 10 2022 123 607.2

(51) Int. Cl. B60L 53/16; B60L 53/22; H01M 10/42

(52) U.S. Cl. CPC B60L 53/16; B60L 53/22; H01M 10/425

(57) ABSTRACT

A high-voltage device (1) has a high-voltage battery (2), a first high-voltage consumer system (3), at least one second high-voltage consumer system (4), and a charging terminal (6). The high-voltage battery (2) is connected electrically to the first high-voltage consumer system (3) by a main contactor (5), and the high-voltage battery (2) is connected electrically to the charging terminal (6) by a charging contactor (7). The charging contactor (7) is connected to the main contactor (5) in parallel. A first three-point switch (8) is provided and electrically connects the second high-voltage consumer system (4).

### CROSS REFERENCE TO RELATED APPLICATION

This application claims priority on German Patent Application No 10 2022 123 607.2 filed Sep. 15, 2022, the entire disclosure of which is incorporated herein by reference.

### BACKGROUND

### Field of the Invention

The invention relates to a high-voltage device for a motor vehicle.

### Related Art

Motor vehicles with electric drive are well known and include motor vehicles with a battery-electric drive and motor vehicles with a hybrid drive that has a battery-electric drive and an internal combustion engine. The battery-electric drive comprises a high-voltage battery, an electric prime mover that is powered by the high-voltage battery and a charging terminal. The charging terminal can be connected to a charging network so that the high-voltage device can charge the high-voltage battery.

DE 10 2019 129 705 A1 discloses a high-voltage device with only one consumer terminal and one charging terminal. Thus, all consumers are connected to the high-voltage power potential of the high-voltage battery at the same time as soon as the main contactor is closed. This is necessary when a consumer of the motor vehicle is to be operated. Then, the high-voltage battery is connected via the main contactor.

The charging contactor is closed to connect a charging terminal to the high-voltage battery so that the high-voltage battery can be charged. The main contactor typically can be opened when a supply of the consumers is not required.

This has the general disadvantage that all consumers are always connected to the high-voltage power potential of the high-voltage battery at the same time as soon as the main contactor is closed, although this is not required. This leads to undesirable passive losses when voltage is applied, for example in internal measurement circuits or in internal safety-relevant discharge circuits.

The problem addressed by this invention is to create a high-voltage device with reduced undesirable losses.

### SUMMARY OF THE INVENTION

One embodiment of the invention relates to a high-voltage device with a high-voltage battery, a first high-voltage consumer system, at least one second high-voltage consumer system, and a charging terminal. The high-voltage battery is connected electrically to the first high-voltage consumer system by means of a main contactor, and the high-voltage battery is electrically connected to the charging terminal by means of a charging contactor. The charging contactor is connected to the main contactor in parallel. A first three-point switch is provided and electrically connects the second high-voltage consumer system. As a result, it is possible for the second high-voltage consumer system to be connected for a power supply while the first high-voltage consumer system is switched off. Thus, a saving of electrical energy can be achieved, because an unnecessary supply of power can be avoided.

At least a third high-voltage consumer system may be provided. This embodiment has a second three-point switch that electrically connects the third high-voltage consumer system. As a result, for example, two ancillary second or third high-voltage consumer systems can be created in addition to a primary first high-voltage consumer system, which can be supplied independently. Thus, a scaled use and power supply can be achieved to realize a scaled savings.

In another aspect of the invention, at least one nth high-voltage consumer system is provided along with a (n−1)th three-point switch that electrically connects the nth high-voltage consumer system, wherein n is: 3, 4, 5, 6, 7, 8, 9, etc. As a result, further ancillary nth high-voltage consumer systems can be created and can be supplied independently. This allows a further scaled use and power supply to be achieved and can realize greatly scaled savings.

The respective three-point switch of some embodiments has a first switch position, in which the second, third, and/or nth high-voltage consumer system is connected to the main contactor and/or to the high-voltage battery. Thus, by means of the main contactor, a respective power supply to the high-voltage battery can be switched on or off.

In some embodiments, the respective three-point switch has a second switch position, in which the second, third, and/or nth high-voltage consumer system is connected to the charging terminal. Thus, by means of the charging contactor, a power supply to the high-voltage battery can be switched on or off, or a connection to the charging terminal can be achieved.

The respective three-point switch may have a third switch position, in which the second, third, and/or nth high-voltage consumer system is disconnected, in particular not connected to the main contactor and/or not to the high-voltage battery and also not to the charging terminal. Thus, a shutdown of any power supply can be achieved.

The first high-voltage consumer system may comprise at least one drive unit or a plurality of drive units for driving a motor vehicle. Thus, the primary supply of the at least one drive unit can be achieved while other units can be switched off, or conversely a primary supply of the at least one drive unit can be switched off while other units can be powered.

The at least one second high-voltage consumer system may comprise at least one ancillary high-voltage consumer, such as a high-voltage heater and/or a high-voltage NC compressor. As a result, at least one high-voltage consumer can be supplied, while other units can be switched off, or vice versa.

One main contactor or one common main contactor and/or one charging contactor or one common charging contactor may be provided for each phase. As a result, each phase can be switched off or on safely.

Some embodiments, have one three-point switch or one common three-point switch per phase. This allows each phase to be switched safely.

The invention is described in detail below with reference to the drawings.

### BRIEF DESCRIPTION OF THE DRAWINGS

FIG. 1 is a schematic illustration of a first embodiment of a high-voltage device according to the invention.

FIG. 2 is a schematic illustration of a second embodiment of a high-voltage device according to the invention.

### DETAILED DESCRIPTION

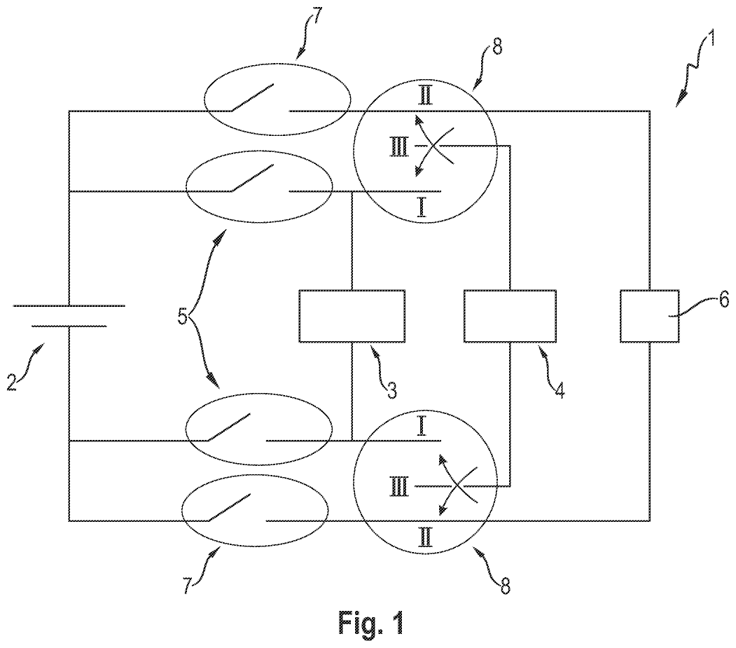

It will be appreciated by those skilled in the art that the diagrams presented herein represent conceptual views of illustrative circuitry, hardware and software embodying the principles of the disclosure. Similarly, any functions or methods implied by these block diagrams may be represented in computer readable media and so executed by a computer or processor, whether or not such computer or processor is explicitly shown. FIG. 1 is a schematic illustration of a first embodiment of a high-voltage device 1 with a high-voltage battery 2, a first high-voltage consumer system 3, and at least a second high-voltage consumer system 4.

The first high-voltage consumer system 3 is electrically connectable or separable via a main contactor 5 to both poles of the high-voltage battery 2, depending on whether the main contactor 5 is closed or open. If the main contactor 5 is closed, then the first high-voltage consumer system 3 is connected to the high-voltage battery 2, switched with it, and the first high-voltage consumer system 3 can be operated. If the main contactor 5 is open, then the first high-voltage consumer system 3 is not connected to the high-voltage battery 2, not switched with it, and the first high-voltage consumer system 3 cannot be operated.

For example, the first high-voltage consumer system 3 can comprise at least one drive unit or a plurality of drive units, in particular for driving a motor vehicle. A drive unit for the front axle and/or a drive unit for the rear axle can be provided. Such a drive unit can comprise, for example, an electric machine and optionally a transmission.

The high-voltage device 1 also comprises a charging terminal 6. This charging terminal 6 is used to charge the high-voltage battery 2 by connecting the charging terminal 6 to a charging network (not shown), in particular with a charging cable or the like. The charging terminal 6 can be connected to or disconnected from the high-voltage battery 2 with its poles by means of a charging contactor 7, depending on whether the charging contactor 7 is closed or open. If the charging contactor 7 is closed, then the charging terminal 6 is connected to the high-voltage battery 2 and switched with it for charging the high-voltage battery 2. If the charging contactor 7 is open, then the charging terminal 6 is not connected to the high-voltage battery 2 and is not switched with it.

For example, to charge the high-voltage battery 2, the charging contactor 7 can be closed while the main contactor 5 is open.

Accordingly, the high-voltage battery 2 can be connected electrically to the first high-voltage consumer system 3 by a main contactor 5, and the high-voltage battery 2 can be connected electrically to the charging terminal 6 by a charging contactor 7. In the embodiment of FIG. 1, the charging contactor 7 is connected in parallel to the main contactor 5.

The high-voltage device 1 of FIG. 1 also comprises a second high-voltage consumer system 4 that can be connected electrically by means of a first three-point switch 8. The first three-point switch 8 has a first switch position I in which the second high-voltage consumer system 4 is connected to the main contactor 5 and/or to the high-voltage battery 2. The first three-point switch 8 also has a second switch position II in which the second high-voltage consumer system 4 is connected to the charging terminal 6. The first three-point switch 8 further has a third switch position III in which the second high-voltage consumer system 4 is disconnected, in particular not connected to the main contactor 5 and/or not to the high-voltage battery 2 and also not to the charging terminal 6.

In the embodiment of FIG. 1, the at least one second high-voltage consumer system 4 comprises at least one high-voltage ancillary consumer, for example a high-voltage heater and/or a high-voltage NC compressor. These high-voltage ancillary consumers can be operated and/or switched off independently of consumers of the first high-voltage consumer system 3.

According to FIG. 1, a main contactor 5 can be used for each phase or a common main contactor 5 can be used for all phases and/or a charging contactor 7 can be provided for each phase or a common charging contactor 7 can be provided for all phases.

A three-point switch 8 also can be provided per phase, or a common three-point switch can be provided for all phases.

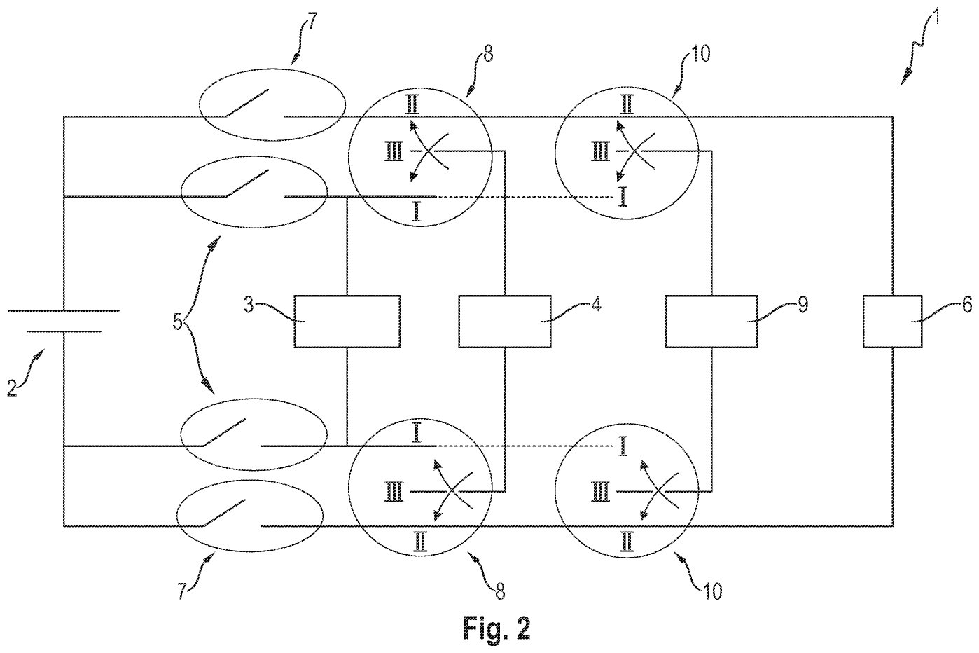

FIG. 2 is a schematic illustration of a second embodiment of a high-voltage device 1 with a high-voltage battery 2, a first high-voltage consumer system 3, a second high-voltage consumer system 4, and at least a third high-voltage consumer system 9. A further high-voltage consumer system 9 also can be provided in principle, for example also a plurality of further high-voltage consumer systems 9. For example, at least one nth high-voltage consumer system 9 can also be provided, where n is an integer greater than 2, i. e. n=3, 4, 5, 6, 7, 8, 9, etc.

The first high-voltage consumer system 3 is electrically connectable or separable via a main contactor 5 to both poles of the high-voltage battery 2, depending on whether the main contactor 5 is closed or open. If the main contactor 5 is closed, then the first high-voltage consumer system 3 is connected to the high-voltage battery 2, switched with it, and the first high-voltage consumer system 3 can be operated. If the main contactor 5 is open, then the first high-voltage consumer system 3 is not connected to the high-voltage battery 2, not switched with it, and the first high-voltage consumer system 3 cannot be operated.

For example, the first high-voltage consumer system 3 can comprise at least one drive unit or plural drive units for driving a motor vehicle. Thus, a drive unit for the front axle and/or a drive unit for the rear axle can be provided. Such a drive unit can comprise, for example, an electric machine and optionally a transmission.

Furthermore, the high-voltage device 1 comprises a charging terminal 6. This charging terminal 6 is used to charge the high-voltage battery 2 by connecting the charging terminal 6 to a charging network (not shown) with a charging cable or the like. The charging terminal 6 can be connected to or disconnected from the high-voltage battery 2 with its poles by means of a charging contactor 7, depending on whether the charging contactor 7 is closed or open. If the charging contactor 7 is closed, then the charging terminal 6 is connected to the high-voltage battery 2 and switched with it for charging the high-voltage battery 2. If the charging contactor 7 is open, then the charging terminal 6 is not connected to the high-voltage battery 2 and is not switched with it.

For example, to charge the high-voltage battery 2, the charging contactor 7 can be closed while the main contactor 5 is open.

Accordingly, the high-voltage battery 2 can be electrically connected to the first high-voltage consumer system 3 by a main contactor 5, and the high-voltage battery 2 can be electrically connected to the charging terminal 6 by a charging contactor 7. According to the embodiment of FIG. 2, the charging contactor 7 is connected in parallel to the main contactor 5.

Furthermore, it can be seen from FIG. 2 that the high-voltage device 1 comprises at least a second high-voltage consumer system 4 that can be electrically connected by means of a first three-point switch 8.

According to FIG. 2, at least a third high-voltage consumer system 9 is provided along with a second three-point switch 10 that electrically connects the second high-voltage consumer system 9.

Optionally, at least one nth high-voltage consumer system can also be provided, wherein a (n−1)th three-point switch is also provided, which electrically connects the nth high-voltage consumer system, wherein n is an integer greater than 2, i.e. n=3, 4, 5, 6, 7, 8, 9, etc.

The respective three-point switch 8, 10 has a first switch position I, in which the second high-voltage consumer system 4 or the third high-voltage consumer system 9 or the nth high-voltage consumer system is connected to the main contactor 5 and/or to the high-voltage battery 2. The respective three-point switch 8, 10 also has a second switch position II, in which the second high-voltage consumer system 4 or the third high-voltage consumer system 9 or the nth high-voltage consumer system is connected to the charging terminal 6. Furthermore, the respective three-point switch 8, 10 has a third switch position III, in which the second high-voltage consumer system 4 or the third high-voltage consumer system or the nth high-voltage consumer system is disconnected, and thus not connected to the main contactor 5 and/or not to the high-voltage battery 2 and also not to the charging terminal 6.

According to the embodiment of FIG. 2, the at least one second high-voltage consumer system 4 comprises at least one high-voltage ancillary consumer. The third high-voltage consumer system 9 also comprises at least one high-voltage ancillary consumer, for example a high-voltage heater and/or a high-voltage A/C compressor, etc. These high-voltage ancillary consumers can therefore be operated and/or switched off independently of consumers of the first high-voltage consumer system 3.

According to FIG. 2, a main contactor 5 can be used for each phase or a common main contactor 5 can be used for all phases and/or a charging contactor 7 can be provided for each phase or a common charging contactor 7 can be provided for all phases.

A three-point switch 8, 10 can also be provided per phase, or a common three-point switch 8, 10 can be provided for all phases.

1. A high-voltage device (1) with a high-voltage battery (2), a first high-voltage consumer system (3), and at least one second high-voltage consumer system (4), and a charging terminal (6), wherein the high-voltage battery (2) is electrically connected to the first high-voltage consumer system (3) by means of a main contactor (5), and the high-voltage battery (2) is electrically connected to the charging terminal (6) by means of a charging contactor (7), wherein the charging contactor (7) is connected to the main contactor (5) in parallel, characterized in that a first three-point switch (8) is provided, which electrically connects the second high-voltage consumer system (4).

2. The high-voltage device (1) of claim 1, further comprising at least a third high-voltage consumer system (9) and a second three-point switch (10) that electrically connects the third high-voltage consumer system (9).

3. The high-voltage device (1) of claim 1, further comprising at least one nth high-voltage consumer system and a (n−1)th three-point switch that electrically connects the nth high-voltage consumer system, wherein n is an integer greater than 2.

4. The high-voltage device (1) of claim 3, wherein the respective three-point switch (8, 10) has a first switch position, in which the second, third, and/or nth high-voltage consumer system is connected to the main contactor (5) and/or to the high-voltage battery (2).

5. The high-voltage device (1) of claim 3, wherein the respective three-point switch (8, 10) has a second switch position, in which the second, third, and/or nth high-voltage consumer system is connected to the charging terminal (6).

6. The high-voltage device (1) of claim 3, wherein the respective three-point switch (8, 10) has a third switch position, in which the second, third, and/or nth high-voltage consumer system is disconnected and hence not connected to any of the main contactor (5), the high-voltage battery (2) and the charging terminal (6).

7. The high-voltage device (1) of claim 1, wherein the first high-voltage consumer system (3) comprises at least one drive unit for driving a motor vehicle.

8. The high-voltage device (1) of claim 1, wherein the at least one second high-voltage consumer system (4) comprises at least one ancillary high-voltage consumer.

9. The high-voltage device (1) of claim 1, further comprising one main contactor (5) or one common main contactor (5) per phase.

10. The high-voltage device (1) of claim 1, further comprising one charging contactor (7) or one common charging contactor (7) are provided per phase.

11. The high-voltage device (1) of claim 1, wherein one three-point switch (8, 10) or one common three-point switch (8, 10) is provided per phase.
